(19) United States
(12) Patent Application Publication
(10) Pub. No.: US 2021/0201348 A1
(43) Pub. Date: Jul. 1, 2021

(54) SYSTEMS FOR DYNAMICALLY RENDERING MERCHANDISING AND SOCIALIZING MODULES WITHIN A BROWSER WINDOW

(71) Applicant: Jay Bakhshi, Centerville, OH (US)

(72) Inventor: Jay Bakhshi, Centerville, OH (US)

(21) Appl. No.: 16/929,199

(22) Filed: Jul. 15, 2020

Related U.S. Application Data
(60) Provisional application No. 62/876,030, filed on Jul. 19, 2019.

(51) Int. Cl. G06Q 30/02; G06Q 30/06; G06Q 50/00

(52) U.S. Cl. CPC G06Q 30/0253; G06Q 50/01; G06Q 30/0641

(57) ABSTRACT

A system for merchandising and socializing within a browser window to a user using a campaign module over Internet and rendering sub-windows accordingly using the module.

### FIELD OF THE INVENTION

The invention relates generally to web based systems for dynamically rendering merchandising and socializing modules within a browser window using JavaScript technology on an electronic network.

### BACKGROUND OF THE INVENTION

Some of today's market place websites include Ebay®, Taoba®, Amazon®, Walmart®, eBay®, Target®, Alibaba®, Flipkart® and NewEgg® just to name a few. These site typically provide a conventional use of databases for storing information relating to inventory-based information for many products offered by the particular site. Prices are set by a party, typically, the seller who dictates the cost to the potential buyer. Traditionally, these sites are either straight sales sites dictated by seller, or third party sites which enable bidding on the product.

The information in a campaign for a good/service may include a number of elements, including its price, postal address, physical characteristics of the good/service including its specifications and images such as photographs, videos, and even 3D videos. Information can be provided to a person using the Internet, or other electronic communications network, for display on a computer to the person in the form of a search result. The information can include text or photograph(s), audio and/or video.

Historically, Java® or Flash® were used for used for rendering the site to the viewer. More recently, HTML5 and its related technologies aid for adding animation and limited interactivity to web pages. These e-commerce sites are built using traditional price setting and shopping cart, checkout platforms.

Advertising on the internet is in large part impression based, the price being dependent on the number of times an advertisement is presented to a user. The current form of impression based random and interruptive advertising is time consuming, expensive and allows for significant waste in audience, engagement and media spend. Ad units can be targeted to individuals targeting an individual's web-browsing behavior the pages they have visited in order to select which advertisements to display to that individual. Additionally, automated content based systems display to the end user. Ads are also created and placed on a site based on site content.

Social media sites have also started providing forums for selling items, such as Facebook®. These sites provide for a good or service to be listed on its site for sale and the user enters a separate sub-window for viewing exclusively the good or service.

While these prior systems have been successful in their own right, there is a need to provide a web based systems for dynamically rendering merchandising and socializing modules within a browser window which better addresses the needs of the consumer and manufacturer in a direct manufacturer to consumer way which enables the delivery of data, information and social network communication in a unique manner not heretofore provided.

### SUMMARY OF THE INVENTION

It is an object to provide web based systems for dynamically rendering merchandising and socializing modules within a browser window to a user.

It is a further object to improve merchandising systems.

It is another object to improve social networking systems.

Accordingly, one embodiment includes a system for merchandising and socializing within a browser window to a user using a campaign module. In one embodiment, the system includes:

A system for merchandising and socializing within a browser window to a user using a campaign module over Internet, which includes:

a web based user interface program residing on a computer based server which is operably connected to the Internet, the program requiring access through a browser window and registration by way of one or more user-specified operations to be applied to signals and/or states to be provided as operands for the one or more user-specified operations categorizing themselves as at least one of a buyer or seller;

a first campaign module of the web based user interface program requiring one or more user-specified operations to be applied to signals and/or states to be provided as operands for the one or more user-specified operations for creating a first campaign data including at least one of a first product data and a first service data, including at least one of a first description data and a first image data, and including at least one of a first defined price data and a first defined number of units data set by a first user, the first campaign module generating output signals and/or states based at least in part on the creating for rendering viewable a first campaign data in a first sub-window of said browser window;

a campaign database storing the first campaign data;

a second module of said web based user interface program determining a first acceptance signal by way of one or more user-specified operations to be applied to signals and/or states to be provided as operands for the one or more user-specified operations including at least one of an acceptable defined price data and acceptable defined number of units data is provided, the second module generating output signals and/or states based at least in part on the determining, wherein the second module include generating an output signal including a live campaign data and rendering the first campaign data viewable in a second sub-window of the browser window enabling completing an acquisition transaction on one of the first product and the first service data by at least one user of the web based user interface program; and

a messaging module of said web based user interface program for generating messages based at least in part on one or more user-specified operations to be applied to signals and/or states to be provided as operands for the one or more user-specified operations, and generating output signals and/or states based at least in part on the generating which renders a viewable messaging sub-window in the browser window adjacent one of the first sub-window and the second sub-window within the browser window for user to user communication through the messaging sub-window without exiting the browser window. The messaging module provides message signals between users joined to said first campaign.

A module for transforming the first campaign data by way of one or more user-specified operations to be applied to signals and/or states to be provided as operands for the one or more user-specified operations includes at least one of a first redefined defined price data and a first redefined bulk purchase number of units data set by a second user and a monitoring module which upon at least one of the redefined price data and the redefined bulk purchase number of units being accepted, the module for transforming generates output signals and/or states based at least in part on the transforming which are rendered in the second sub-window.

Another module persistently scans and compares the campaign database against second campaign data and based one or more user-specified operations to be applied to signals and/or states to be provided as operands for the one or more user-specified operations and determining a like prior campaign data is in the campaign database, and generating an output signal to said user of said like prior campaign, and a signal prompts the user to select the like prior campaign or to continue with the second campaign for being stored in the campaign database. The first module by way of one or more user-specified operations to be applied to signals and/or states to be provided as operands for the one or more user-specified operations requires one of creation and editing product or service data, including categorizing data, image data, description data, price data and a selling point description message data. The creation and editing of shipment data, address data, weight data, and fulfillment data as well is provided.

The system provides an output signal rendering image data and text data in a third sub-window of the browser window via the web based user interface in an orbital pattern format such that when the user pans over the data in said third window with a cursor the data moves in the orbit permitting a predetermined number of image and text to be rendered within the orbit. This orbiting is an independent feature of the invention along with the messaging module based at least in part on one or more user-specified operations to be applied to signals and/or states to be provided as operands for the one or more user-specified operations generating output signals rendering a viewable messaging sub-window in said browser window adjacent the first sub-window within the browser window for user to user communication without exiting said browser window.

Another module aspect of the invention provides a sub-window of a browser window the web based user interface, employing the campaign database containing campaigns including customized rendering instructions; the campaign server connected to a communications network for receiving campaign data requests, retrieving a campaign from the campaign database according to the campaign data requests and associated campaign member user data for the requested campaign, and formatting the campaign and campaign member user data into a campaign social data string; and rendering the campaign social data string in the sub-window according to the customized rendering instructions.

The server may be implemented with a JavaScript application. The campaign member user data data string may be a JSON or XML string.

A campaign may include a plurality of images of a goods/service and information about the same, and the customized rendering instructions may specify to the users in which to display the images and how to display the information in relation to the images and campaign members. The customized rendering instructions may specify how the user may control the display by the use of controls displayed according to the customized rendering instructions.

The campaign server may further comprise a campaign management tool. The campaign database may be updated for immediate display of updated campaigns to the user.

The system may further include a tracking module to record tracking data comprising user identifying information and user information requests wherein the system maintains a list of campaigns, each campaign comprising one or more than one item for sale, and the system may display alerts to the campaign member user in the sub-window, each alert providing a link to view items in a promotion, where the system determines from the recorded tracking data that the user is a candidate for viewing the promotion.

The system has an artificial intelligence module which can determine that the user is a candidate for viewing a campaign by comparing the recorded user information requests with the items in the campaign to determine that the user has previously viewed similar items. The user identifying data may comprise demographic information about the user and the system may individualize the items in the promotion displayed to the user based on the demographic information and recorded user information requests.

Other objects and advantages of the invention will be more apparent upon reading the following description and viewing the drawings hereinafter. It is to be noted, however, that the appended drawings illustrate only typical embodiments of this invention and are therefore not to be considered limiting of its scope, for the invention may admit to other equally effective embodiments.

### BRIEF DESCRIPTION OF THE DRAWINGS

FIG. 1 is a block diagram depicting one embodiment of the system according to the invention.

FIG. 2 is an illustration of a web browser window user interface of the invention depicting one features of the system according to the invention.

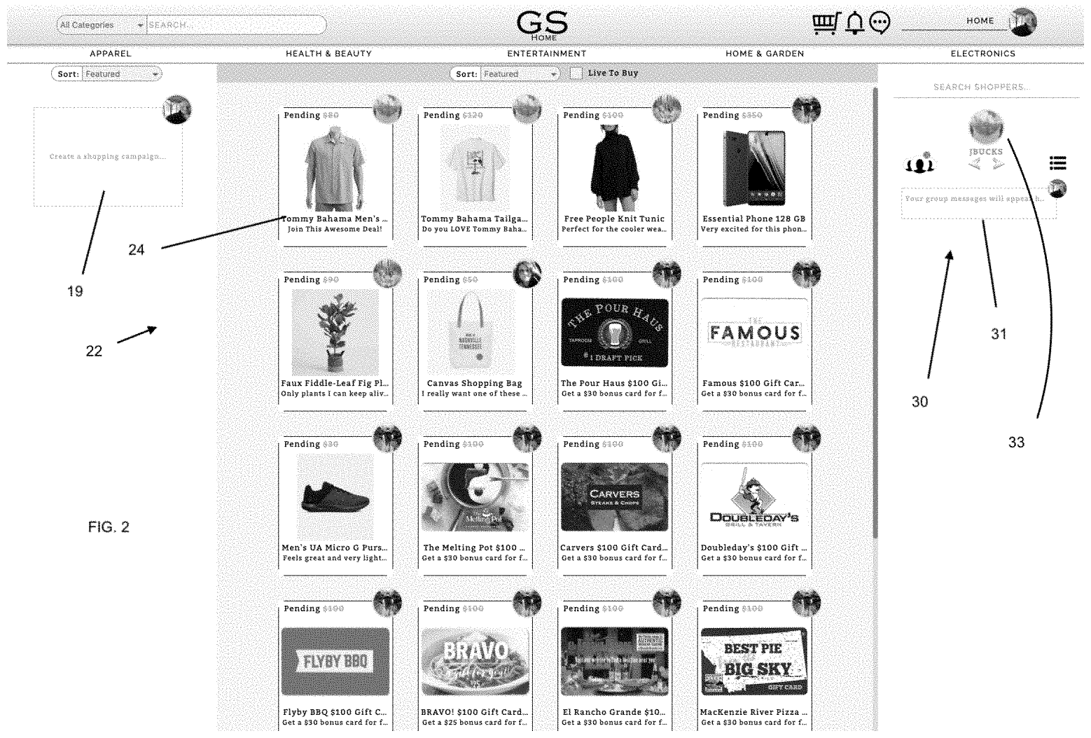

FIG. 3 is an illustration of a module part of web browser user interface depicting a company profile registration process of the system according to the invention.

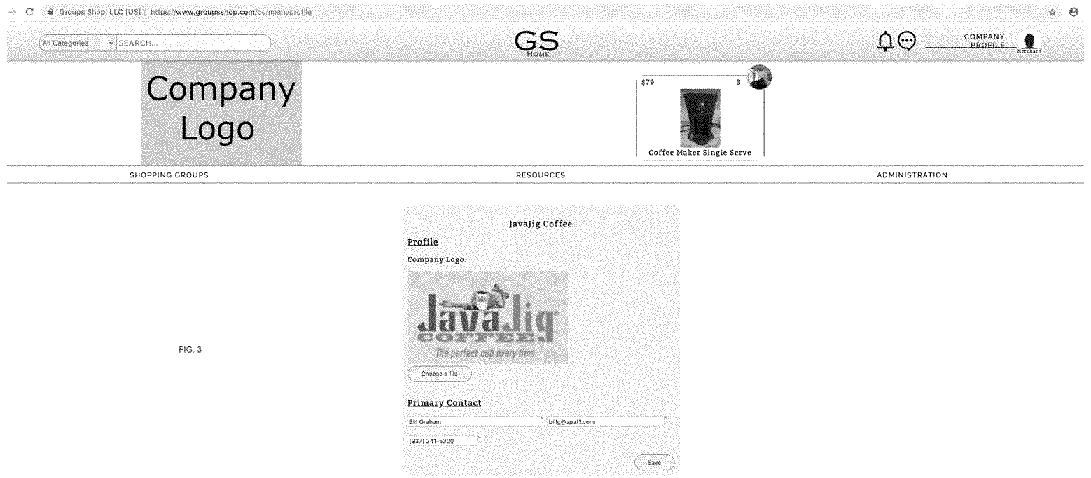

FIG. 4 is an illustration of a module part of web browser user interface depicting a campaign built through the system according to the invention.

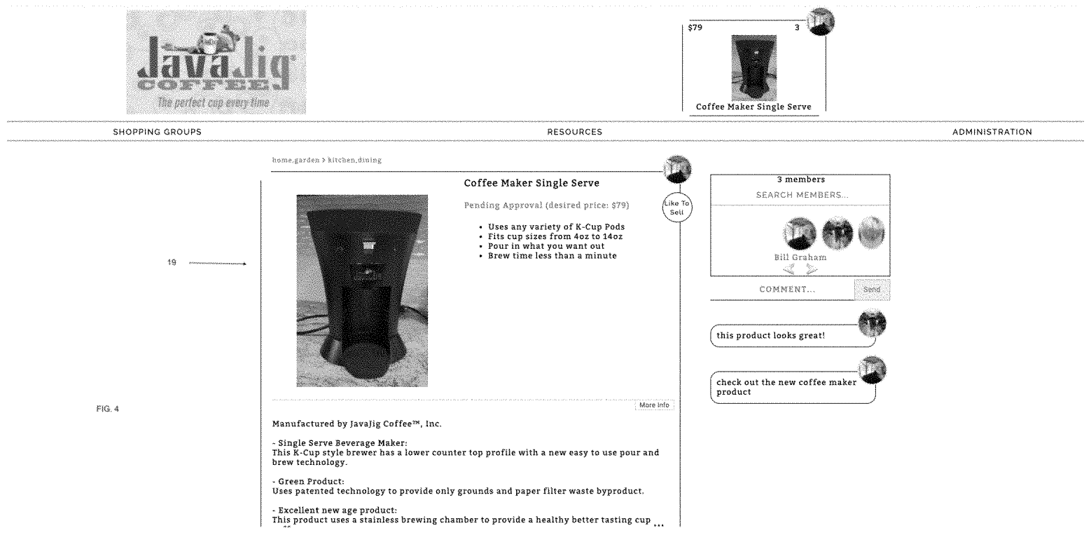

FIG. 5 is another illustration of a campaign module of a web user interface of the system depicting a creation step in one embodiment of the system according to the invention.

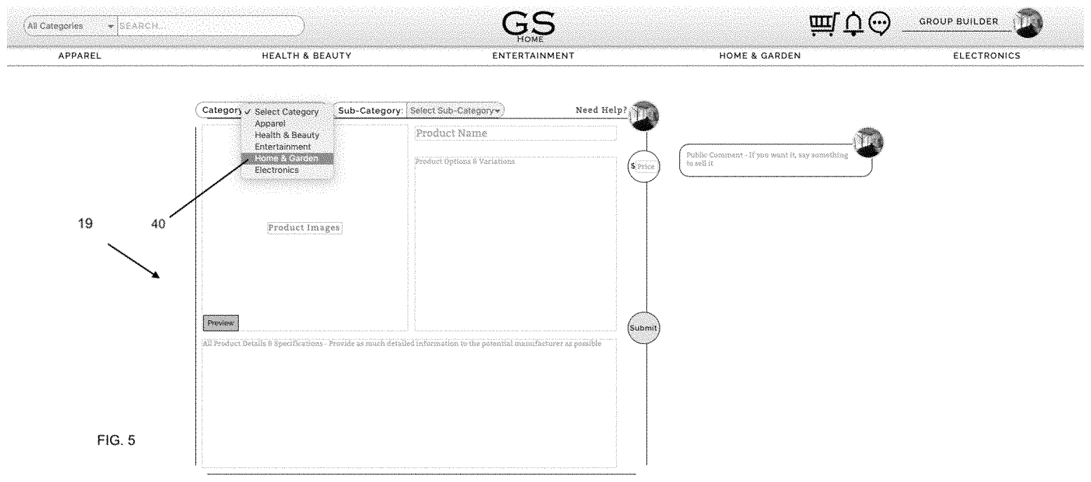

FIG. 6 is another illustration of a campaign module of a web user interface of the system depicting another creation step in one embodiment of the system according to the invention.

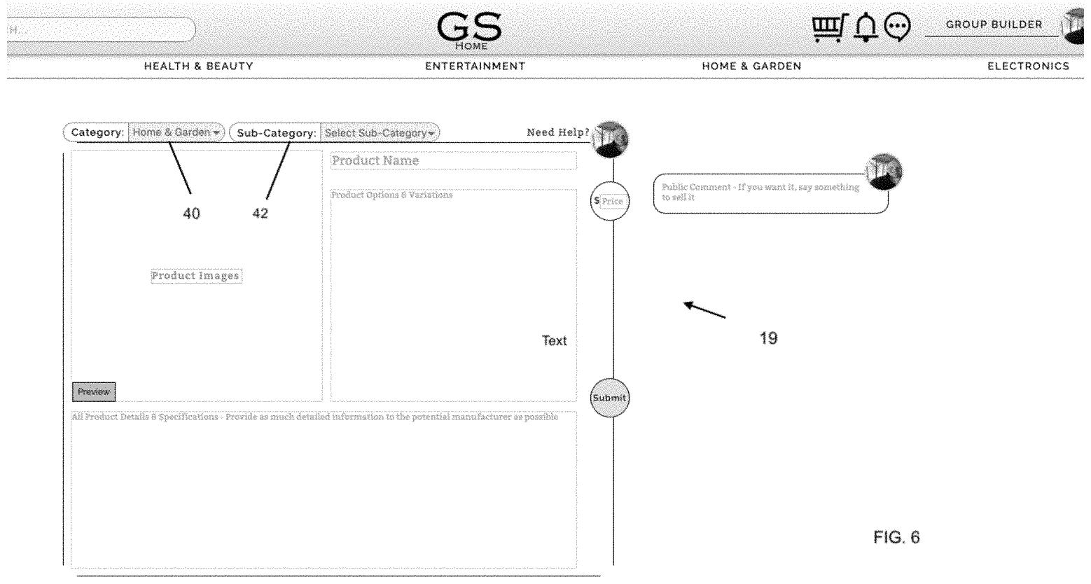

FIG. 7 is another illustration of a campaign module of a web user interface of the system depicting another creation step in one embodiment of the system according to the invention.

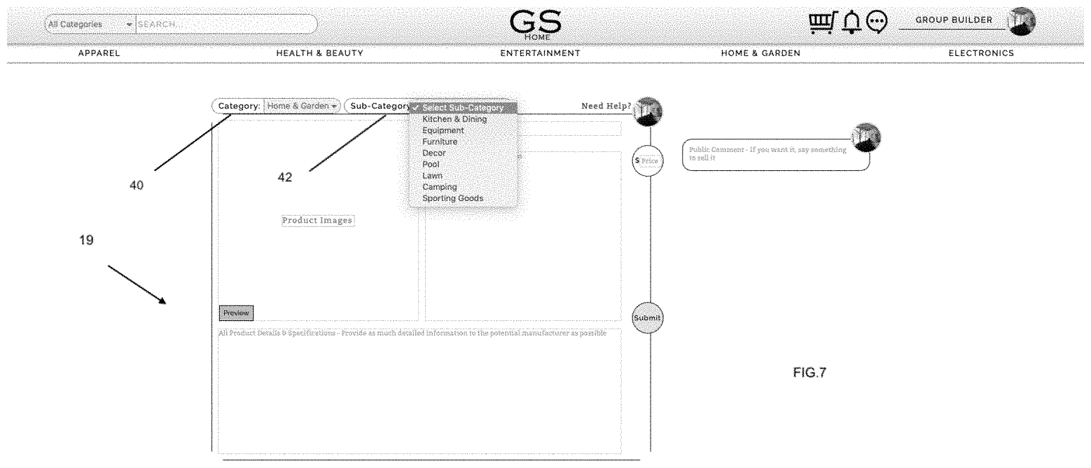

FIG. 8 is another illustration of a campaign module of a web user interface of the system depicting another creation step in one embodiment of the system according to the invention.

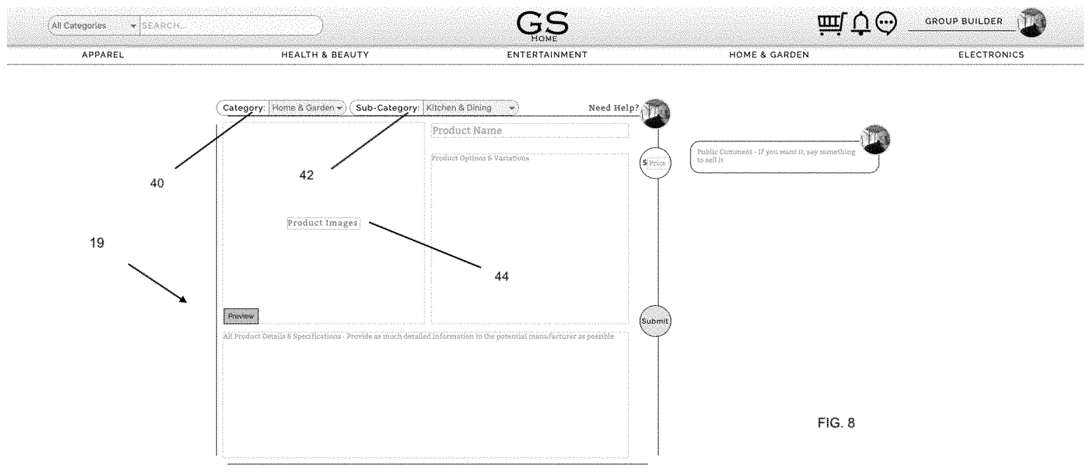

FIG. 9 is another illustration of a campaign module of a web user interface of the system depicting another creation step in one embodiment of the system according to the invention.

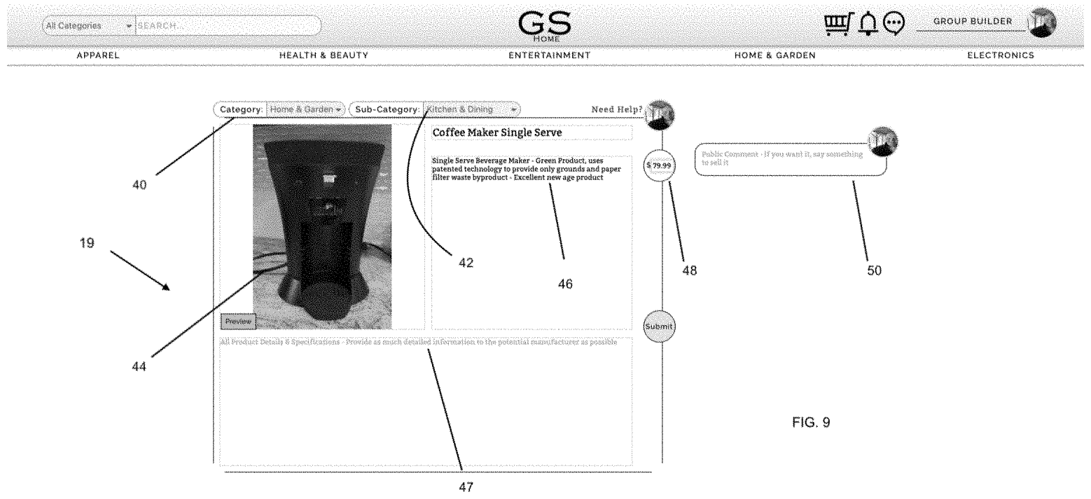

FIG. 10 is another illustration of a campaign module of a web user interface of the system depicting another creation step in one embodiment of the system according to the invention.

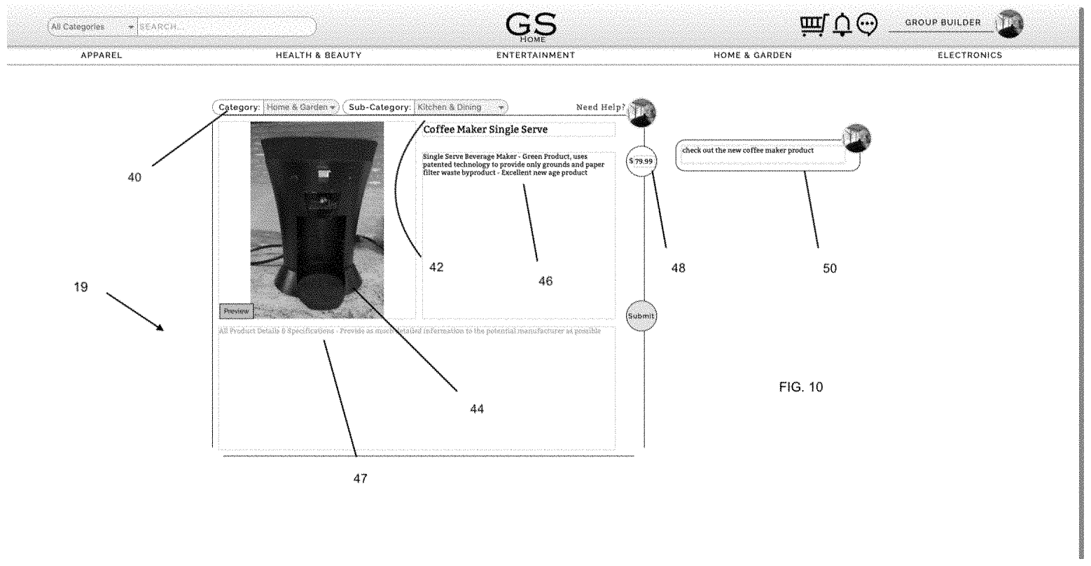

FIG. 11 is an illustration of a part of web user interface depicting an aspect of the system according to the invention with a campaign built and the initial comment from a user.

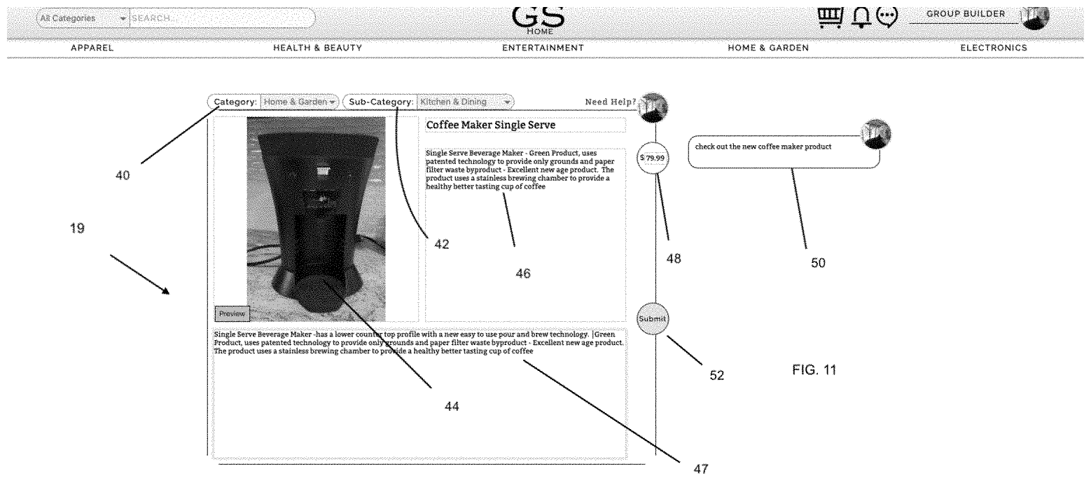

FIG. 12 is an illustration of a web browser window user interface of the invention depicting one features of the system post campaign creation according to the invention.

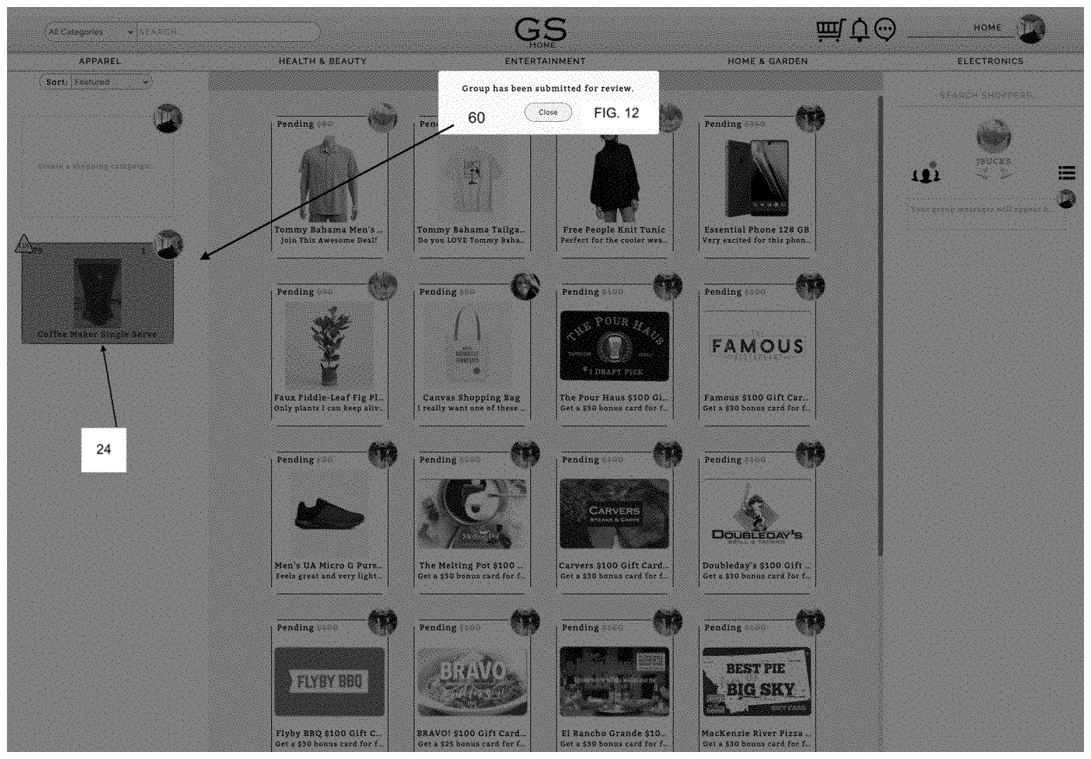

FIG. 13 is an illustration of a web browser window user interface of the invention depicting one features of the system post campaign creation according to the invention.

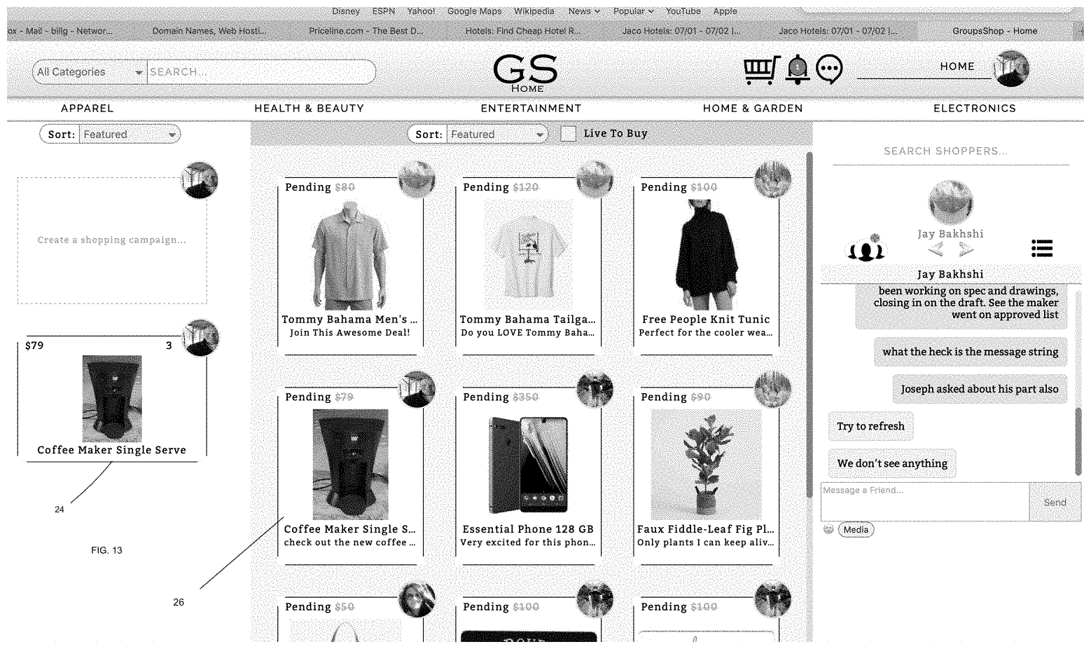

FIG. 14 is an illustration of a sub window part of web user interface depicting items ready for transactions according to the invention.

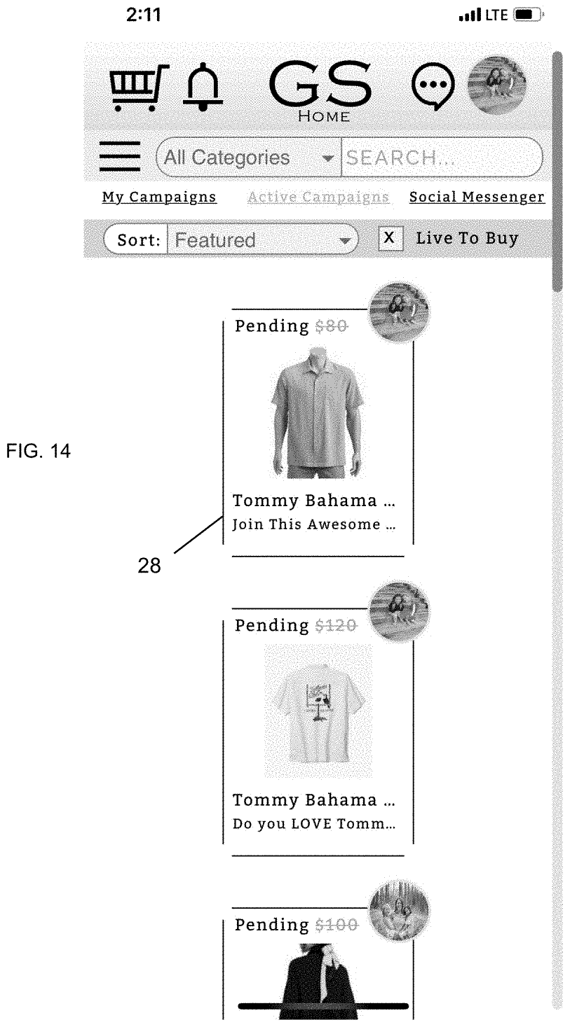

FIG. 15 is an illustration of a social messaging sub-window of web user interface depicting an aspect of the system according to the invention.

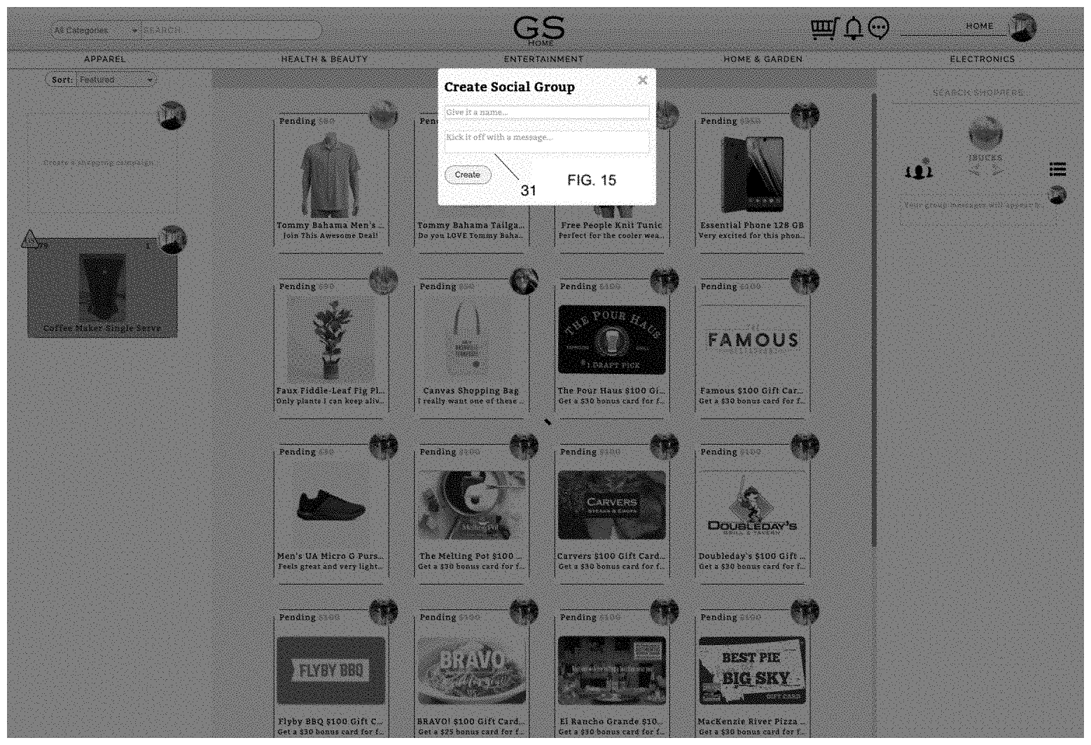

FIG. 16 is an illustration of a social messaging sub-window of web user interface depicting an aspect of the system according to the invention.

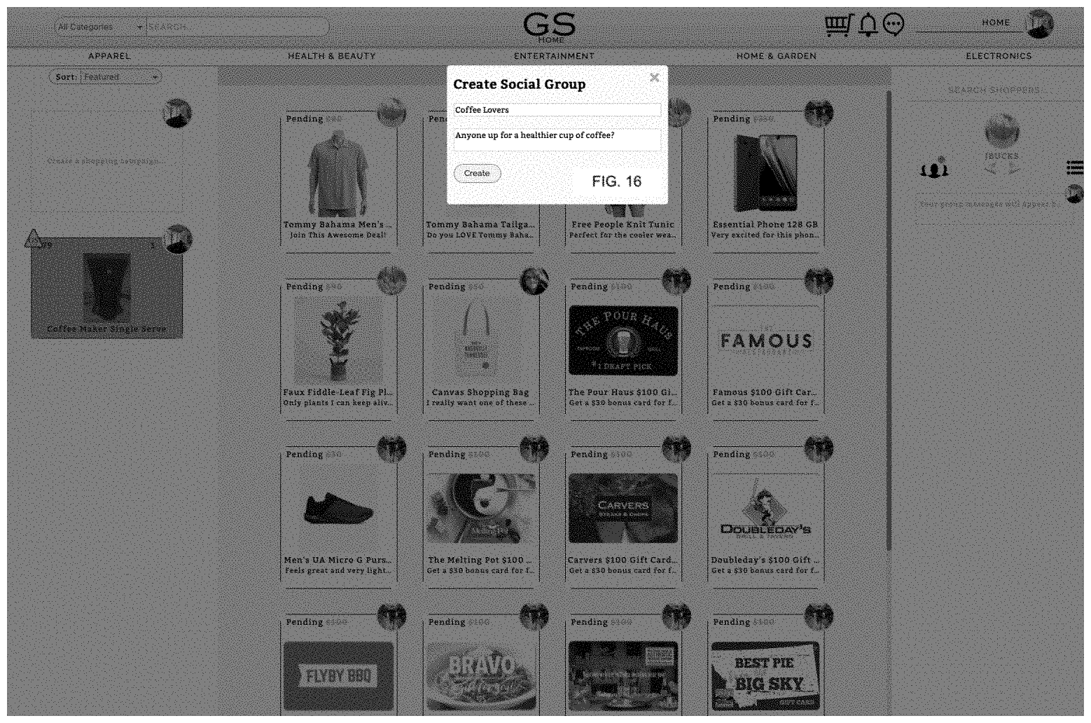

FIG. 17 is an illustration of a web user interface depicting an aspect of the system post a messaging sub-window creation according to the invention.

FIG. 18 is an illustration of a sub-window via orbital rendering module of web user interface of the system according to the invention.

FIG. 19 is an illustration of a sub-window of a messaging module adjacent a campaign module sub-window according to the invention.

FIG. 20 is an illustration of a sub-window of a messaging module adjacent a campaign module sub-window according to the invention.

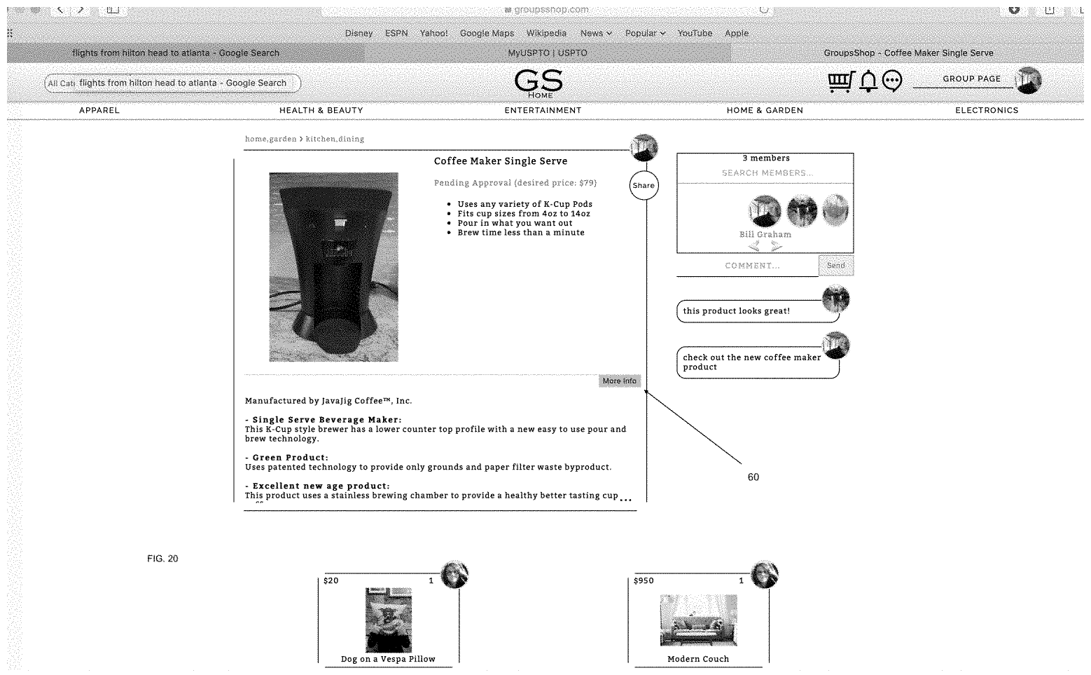

FIG. 21 depicts a drop down sub-window of the invention.

### DETAILED DESCRIPTION OF THE INVENTION

Referring now to the drawings, a web based systems for dynamically rendering merchandising and socializing modules within a browser window generally referred to by the numeral 10. It will be clear to a person skilled in the art that the system 10 will provide a unique and semi-automated system creating a merchandizing and social module platform for various goods and services.

With reference to drawings, according to one embodiment of this invention, the system 10 comprises one or more campaign server(s) 12, supplier (e.g., merchant/supplier) user computer based device 14 and consumer computer based device 16.

Each server 12 may be a single computer system comprising a processor, network interface for accessing an electronic communications network (such as the internet), storage means such as semiconductor memories and hard disk drives, and software running on the processor to cause it to perform the described functions. Such a server may alternatively be a distributed system including multiple processors communicating via a communications network. Such a subsystem may alternatively be a purpose-built processor, or network of processors, comprising computer hardware designed to perform the functions described herein. In all cases, each embodiment of these servers is a particular machine that performs the described functions in the manner described herein as they would be understood by a skilled person. Elements described as servers herein may be alternatively combined to share one or more processors. For example, inventory server 18 and tracking server 20 could be implemented on a single processor with sufficient storage and processing capacity.

User 14, 16 typically access the Internet via a web browser display screen of the user's computing device 14, 16. The web browser interprets web pages, which may consist of source code comprising HTML instructions with embedded programs, such as scripts. In the instant invention, there is provided a web browser window 22. The invention provides for the incorporation of sub-window(s) 24 into a web page browser window 22 by the incorporation in the source code for the web page of instructions to run a program, or script, via a campaign server 12, to manage sub-windows 24, 19, 26, 28, and 30, for example, as will be explained in more detail hereinafter. The source code may specify the portion(s) of the browser window 22 that the campaign server 12 can use, and the sub-window 24, 19, 26, 28, and 30, which may be a rectangular area having a height of a specified number of pixels and a width of a specified number of pixels. The campaign server 12 via campaign modules renders a campaign and social messaging module renders a social communication center, and/or other information, in the sub-windows (24, 19, 26, 28), and 30, respectively which the user(s) 14, 16 can interact with by entering information requests.

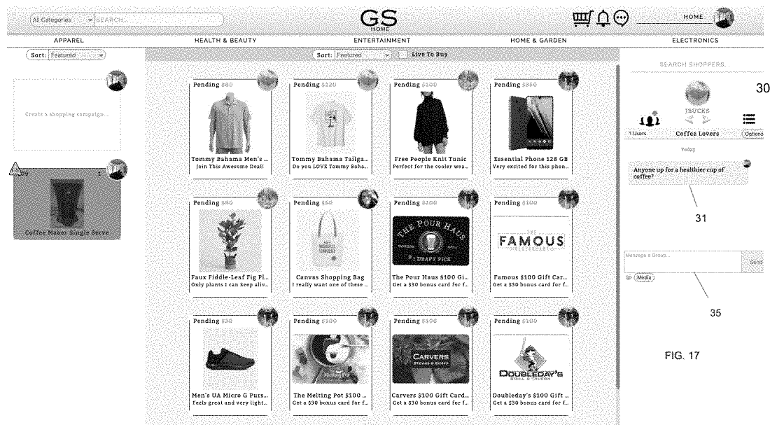

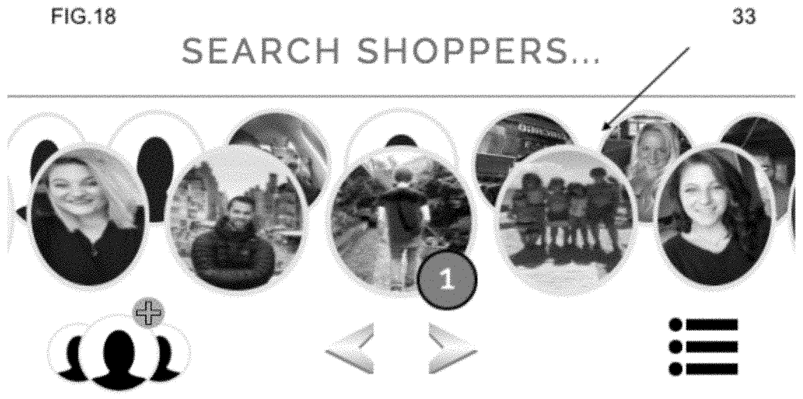

As part of sub-window 30, there is provided messaging module 31 which enables user to user communication, e.g., FIG. 17. Additionally, there is a carousel or orbit module 33 which can include a number of contacts and which rotate in and out of view (e.g., FIG. 18.). For example, there may be more than a predetermined number of viewable contacts in the orbit of rotations, but those contacts exceeding the predetermined number of viewable contacts (e.g. 17) in the orbit will not be viewable. However, as part of the messaging module 31, as a user receives messages from other users, those messaging users are populated closer to the front of the carousel/orbit.

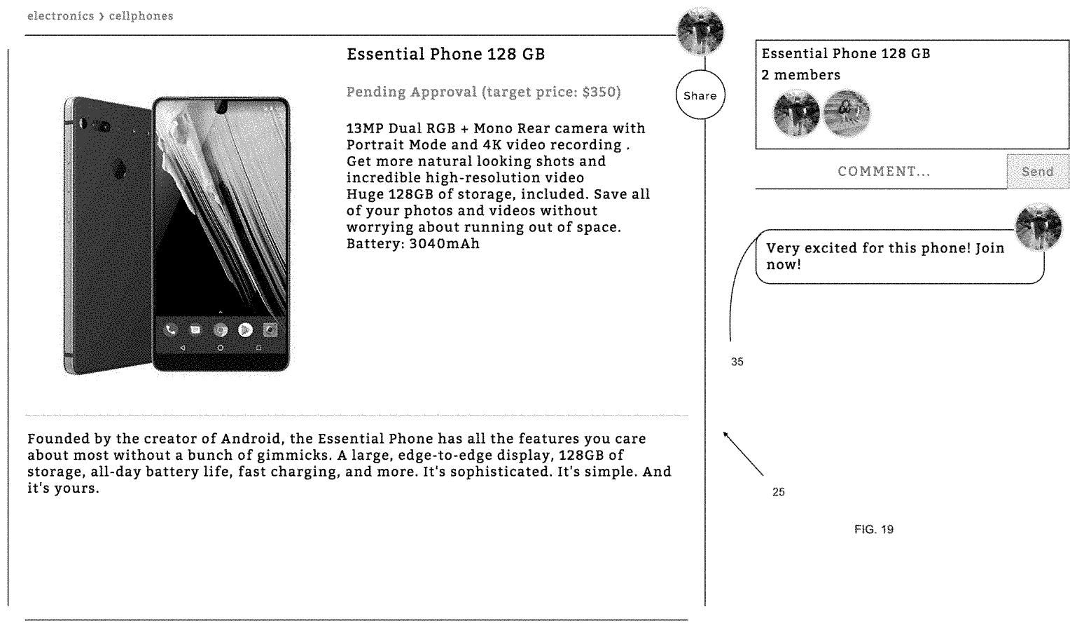

Another feature of the messaging module 31 is campaign message module 35 for posting messages for those users which are joined to a particular campaign as is illustrated in FIG. 19. Still another aspect of the invention is to provide a module which renders image and text data on the web based user interface in a carousel manner such that when a user pans over a user with a cursor of a mouse, for example, the carousel data moves in an orbital or carousel manner permitting a predetermined number of image and text to be rendered within the orbit.

One or more inventory server 18 may include an inventory database 34, is connected to a communications network (such as the Internet). The inventory server 18 may accept inventory data 36 from supplier user 14, or another database, via a real-time feed. Inventory data 36 may also be obtained by other means, such as by being entered directly by a data input device, or by periodic batch updates over the communications network. The inventory data 36 may contain a plurality of text data, numeric data, images, URLs/hyperlinks, rich media (including, but not limited to, photos, creative artwork, streaming banners, video, and audio clips), as well as directives, or rendering instructions, on how, where, and when the inventory data 36 is to be presented on a rich media advertisement. Each campaign includes a data record set describing property campaign information, which may be organized according to individual real estate agent. The data record set contains all rendering information such as ad display duration time, publisher selection, campaign ID, campaign duration, and campaign(s) details.

The inventory data 36 returned to the campaign server 12 in response to a data request 40 may include campaigns or modifications to campaigns that were made immediately before the data request 40 was received, and so allows for the immediate display to users of updated inventory data 36.

Prior to inventory data 36 being rendered for display via the Internet on a web page browser window 22, it will undergo a multi-step approval process on the campaign server 12, which is a workflow allowing supplier users, consumer users and administrators to verify data integrity and appropriateness. If inventory data 36 is being fed from a trusted source, the approval process may be waived for immediate release.

The campaign server 12 may be a JavaScript application, which may be a “.js” file that is invoked by a script tag in the HTML code for a web page. The supplier user computer 14 (or 16) may provide the campaign server 12 with a URL pointing to a .js file, that implements the campaign server 12, or a part thereof. The file may be modified so that the .js file is loaded and executed by consumer user computer 16 browser(s) when it loads the main campaign so that the campaign server 12 may place particular campaign in the sub-window 24, for example, of the browser window 22 containing the supplier user computer 14 page and receive input from the consumer user computer 16. The .js file may be stored on the campaign server computer 14, or in some other location, but is executed and run, at least in part, on the consumer user computer 16 computing device running the consumer user computer 16 web browser. The campaign server 12 may alternatively be written in a scripting language, such as PHP, or another high-level programming language, such as Java or C#.

For example, the campaign server 12 may render a sub-window 24 via a campaign module 19 showing the supplier user computer 14 or user computer 16 product or service.

Sub-window 24 can be created via a campaign module 19. The campaign module 19 provides for image data entry and description data entry, and defined price data entry. The campaign module 19 enables a user to create or edit product or service data, which includes categorizing data 40, 42, adding image data 44, brief description data 46, detailed product/service description data 47, price data 48 and a selling point description message data 50 via messaging module 35. The campaign module 19 also enables certain users, i.e., sellers such as a merchant, to provide shipment details, like address, weight, and fulfillment details. Part of the campaign module 19 includes a submission button 52 and then reverts the user to the web browser window 22 indicating the created campaign 60 under review. Once, the campaign is approved it appears in the sub-window 26 as an active campaign. When the campaign 60 has obtained an accepted buy-sell point based on the campaign criteria, or has been approved otherwise in the system 10, it is rendered “live to buy” in sub-window 28.

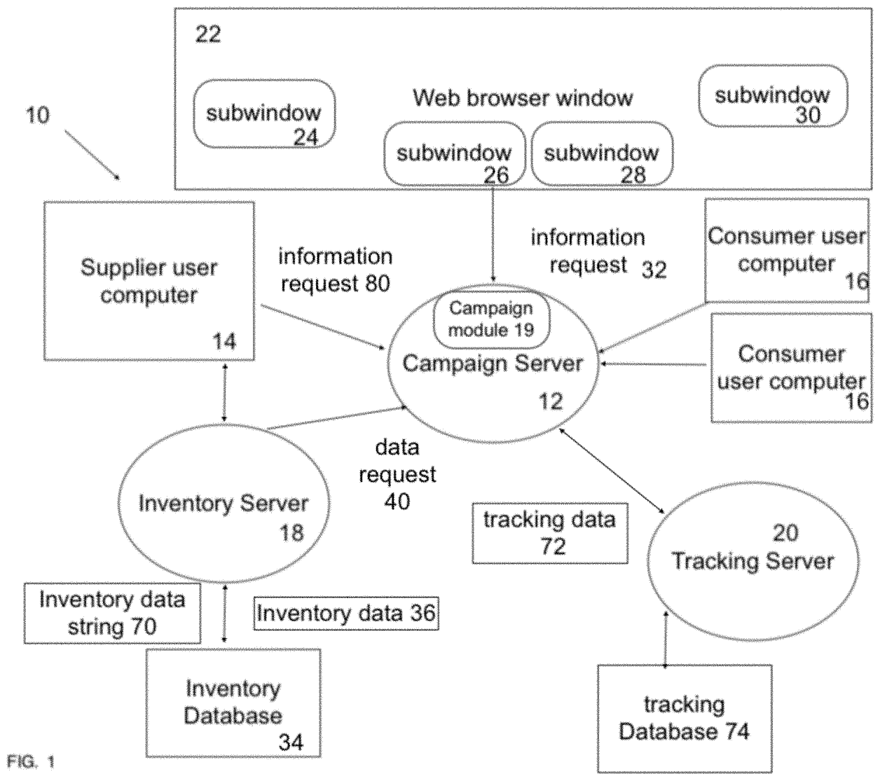

After the user computer 16, for example, clicks on a campaign 26, or performs an equivalent action, indicating that all relevant parameters have been entered, the entered data comprises an information request 32 for the campaign server 12. Referring to FIG. 1, the campaign server 12 may then convert the information request 32 into a data request 40 suitable for submission to the inventory server 18. The inventory server 18, after receiving the data request 40, may then search campaigns in the inventory database 34 based on the parameters provided in the data request 40 to identify campaigns corresponding to the parameters entered by the user computer 16. Each campaign may include information such as that shown in the sub-window 24, 26 or 28, which may include a picture of the goods/service, a description of the goods/service, the asking price, and the campaign creator's name and picture.

A campaign may contain a sequence of images, each having an associated description, such as one or more images and the sub-window 25 may provide a control to allow the user computer 16 to see more detailed image data 44, brief description data 46, detailed product/service description data 47, price data 48 and a selling point description message data 50, or the campaign server 12 may play all the data as a slide show by default.

Instructions for rendering the various images, videos, text descriptions, audio files, and display controls are stored in the campaigns as customized rendering instructions for each campaign. This may include, for each media element, such as an image, the duration to display the element, where to display the element within the sub-window 24, and what link(s) to associate with the element. The customized rendering instructions may also define relationships between elements, such as defining that a particular audio file should be played when a particular image is displayed, or by defining playlists of elements, each being displayed for a specified time in a specified manner. They may define how information, such as price or product/service, is to be displayed in relation to the images.

The customized rendering instructions may also include pre-defined randomization and/or weighting rules. Various graphical transitioning techniques may be used to transition between images or videos, and these may also be specified in the customized rendering instructions. The customized rendering instructions may be entered with the media elements as part of the inventory data 36 supplied by supplier user computer 14. Alternatively the customized rendering instructions may be created or modified by the inventory server 18.

It is an essential element of an embodiment of the invention that the customized rendering instructions be encoded in an inventory data string 36 that is encoded and provided by an inventory server 18 that is remote from the consumer user computer 16 and the processor on which the consumer user computer 16 browser is running. It is also an essential element of an embodiment of the invention that the customized rendering instructions determine how the multimedia elements in a campaign are displayed to the consumer user computer 16. The campaign server 12 only interprets the customized rendering instructions to mechanically render the sub-window 24 and allow the particular user to control it as dictated by the customized rendering instructions. The campaign server 12 may automatically perform operations such as interpolating images to make them fit in the sub-window, or a portion thereof, as directed by the customized rendering instructions. Some elements may include standard rendering instructions such as, for example, an animated GIF file that cycles though a series of images, displaying each for a specified period of time to create an animated image. Such rendering instructions are distinct from the customized rendering instructions, although the customized rendering instructions may be designed to take into account the known standard rendering instructions of such an element.

The sub-windows 24, 26, 28 and 30 may also include a control to allow the supplier user computer 14 or consumer user computer 16 to switch to a different campaign, or to conduct another search or message one or more user. For example, when the user clicks on such a control, thereby making an information request 32, the campaign server 12 may change any of the sub-windows 24, 26 or 28, which display elements from different campaigns. Alternatively, the particular user may choose to obtain more information on the currently displayed campaign by clicking on a link, for example entitled “MORE INFO” 60, in order to view more detailed descriptions in the campaign.

The inventory server 18 may take all the campaigns found in the inventory database 36 matching the data request 40, or a subset of those campaigns, and compile them into an inventory data string 70, which may be structured as JSON or XML having each campaign as an element, and the images, other information and customized rendering instructions as sub-elements of each campaign.

The inventory server 18 may generate a series of inventory data strings 70. The inventory server 18 sends an inventory data string 10 back to the campaign server 12 in response to the data request 40 and the campaign server 12 may then interpret the inventory data string 70 to display campaigns in the sub-window 24, 26, 28 as described above, according to the customized rendering instructions contained in the inventory data string 70 for each campaign.

The campaign server 12 may obtain user identifying information from the computer user computer 16, for example, an IP address or a user ID. It may further include demographic information that the computer user computer 16 provides by interacting with a sub-window 24, 26, 28 such as the computer user computer 16, prior search query, age, interest or other characteristics in the user data profile.

The campaign server 12 may generate a unique ID code for each new user and store that ID in a browser cookie on the user's computer that can be retrieved by the browser, or in a local shared object, or local cache, that is written and read by JavaScript. Alternatively, the campaign server 12 may request that the user register using a dialog displayed in the web browser window 22 via a registration module #, and create a unique user ID, such as the user's email address, and password. The campaign server 12 may then record the user's interactions with the campaign server 12 and associate them with user identifying information, and other information such as the current date and time, to create tracking data. This tracking data 72 may be sent to a tracking server 20 for storage and analysis, again the tracking server 20 can be part or separate from campaign server 12. Optionally, or additionally, tracking data 72 may be saved directly in a cookie on the computer user computer 16, for example. The tracking data 72 may be accumulated over many separate sessions involving interaction with the supplier user computer 14 or the computer user computer 16, which may be unrelated to each other, other than by the fact they are presented by the campaign server 12 to the user in a web browser window 22.

When a user opens a page via web browser window 22 controlled by the campaign server 12, the campaign server 12 may first either retrieve tracking data 72 from a cookie, or obtain user identifying information. If the user has previous tracking data 72 in the tracking database 74, the campaign server 12 may retrieve this using the user identifying information as an index. The campaign server 12 may determine from the tracking data 72, for example, initial settings to use, and may formulate a data request 40 to the inventory server 18 based on the tracking data 72 to obtain an inventory data string 70 to use to initially render the sub-window 26 or 28. For example, the campaign server 12 may determine which type of gods or services that the user is probably interested in, and the price range, from the prior search information contained in the tracking data 72. The user may then be presented with a similar set of campaigns as that user previously requested, including any new inventory data 36 added since the previous request. The campaign server 12 may choose to initially display only those campaigns added since the last recorded date that the user made an information request 32, as determined by the date/time information in the tracking data 72 for that user. This may be done by formulating the data request 40 to the inventory server 18 to request only campaigns added or modified since the prior interaction with the user.

The technology provides for a unique method of displaying multimedia content, including graphics, photographs, and textual descriptions of each campaign. It simplifies and expedites the process of producing online campaign.

With further reference to FIG. 1, the components of the preferred embodiment include an inventory database 34 and an inventory server 18, which may accept campaign updates on a real-time basis. The inventory server 18 may include a client campaign management tool and a system administrator module.

Each campaign may have custom creative content that further enhances the visual effects the displayed item. Such creative content may be included in the inventory data string 70 with associated customized rendering instructions for each campaign in a campaign that is returned to the campaign server 12.

Campaigns can either be entered into the system 10 by each agent using a controlled secure web interface via a real-time feed. A web service may be used to permit the inventory server 18 to query databases directly to retrieve updated Inventory data 36. As mentioned earlier, campaigns may move through a workflow to verify correctness, ensure that the content and photos are appropriate, and for final approval through campaign server 12.

When the user enters web browser window 22 to access campaign server 12, the campaign server 12 first renders initial content in sub-windows, 24, 26, 28, 30. This may be some pre-defined default content, or may be user-specific if the campaign server 12 identifies pre-existing tracking data 72 for the user, as discussed above. For example, the user interacts with a sub-window 24, 26, 28 and sends an information request 32 to the campaign server 12 to request information using specified parameters. The campaign server 12 then formulates a data request 40 and sends it to the inventory server 18, after which the inventory server 18 retrieves data from the inventory database 34 and then constructs an inventory data string 70 and sends it to the campaign server 12. The campaign server 12 interprets the inventory data string 70 and renders the sub-windows, 26 and 28 to display a first set of content for a campaign. Then the supplier user computer 14 interacts with the sub-window 24, 26 and 28 by making information requests 80 and the campaign server 12 modifies the content of the sub-window accordingly. By default, all campaigns have equal exposure on the targeted web items, although campaigns can be weighted for more or less exposure on various web items.

Owners of campaigns are able to check the exposure (impressions) that a campaign has had (e.g. how many times a user has viewed a given campaign), as well as determine how many users “joined” the campaign in order to render the campaign “live.” The campaign server 12 can optionally also provide statistical data such as how long users spent viewing a campaign and the total time spent per session viewing campaigns. Other examples include the total time a user has spent viewing ads of a certain type and price range over a certain price. Such statistics are generated by the tracking server 20 and may be summarized in tracking reports for each campaign that are provided. Such statistics may be used to determine which ads to display to a user and pre-qualify a user to see certain campaigns.

The tracking data 72 may include user search history information, based on searches as specified by user requests comprising information requests 32 entered by a user of the campaign server 12. This may include information on searches made on multiple sites. For example, a single user may interact with a sub-window 26 containing information on clothing and, at a previous time, have interacted with a sub-window 28 containing campaigns of restaurants. The tracking data 72 would then contain information about what was searched for each campaign.

The inventory server 18 may maintain lists of promotional items, sales or other events that are provided by a supplier user computer 14. For example, retailer X may have a promotion whereby the price of certain sleeveless shirts is discounted for a certain period. When the consumer user computer 16 begins to interact with a sub-window 24, the campaign server 12 may retrieve the tracking data 72 from a cookie or from the tracking server 20. Then the campaign server 12 may compare the consumer user computer 16 search history with the list of sales and promotions. If the user had previously searched for sleeveless shirts, the campaign server 12 may determine that the consumer user computer 16 is a candidate for viewing supplier user computer 14's campaign. A candidate for viewing such a promotion may be someone who has searched for items that are comparable to those items that are the subject of the promotion, as indicated by the search history contained in the tracking data 72. Candidates may also be identified by other means, such as by comparison with data provided by a user, which could include information such as the user's age or prior search requests. For example, if the user has a relatively high income level, the campaign server 12 may present more expensive items to the user initially.

If consumer user computer 16 is determined to be a candidate for viewing supplier user computer 14 promotion then, while the consumer user computer 16 is looking at campaigns in a sub-window 26, 28, the campaign server 12 may generate an alert, that may appear in part of the sub-window.

This approach goes far beyond prior traditional merchandising. Here, campaigns are provided in a manner direct consumer to supplier with the advantage of bulk purchasing pricing. Also, tracking information used is based on actions by a user interacting with a sub-window, performing actions that indicate the user's actual interest in particular items or products. This permits a campaign to be crafted and dynamically displayed on an individual basis to greatly enhance the promotion of that content to a user. For example, if Consumer A performs a search in a coffee makers, the real time campaigns appear to Consumer A in the sub-window 26, 28 where the search is performed. If the results change in any way, such as a price and quantity are met to render live the transaction, an alert may appear to Consumer A when that user is viewing any campaign. Consumer A then has the choice to view the alert by clicking on a provided link. Following Consumer A's engagement with the coffee maker alert, the sub-window 26, 28 reverts back to the item being viewed before the alert was introduced.

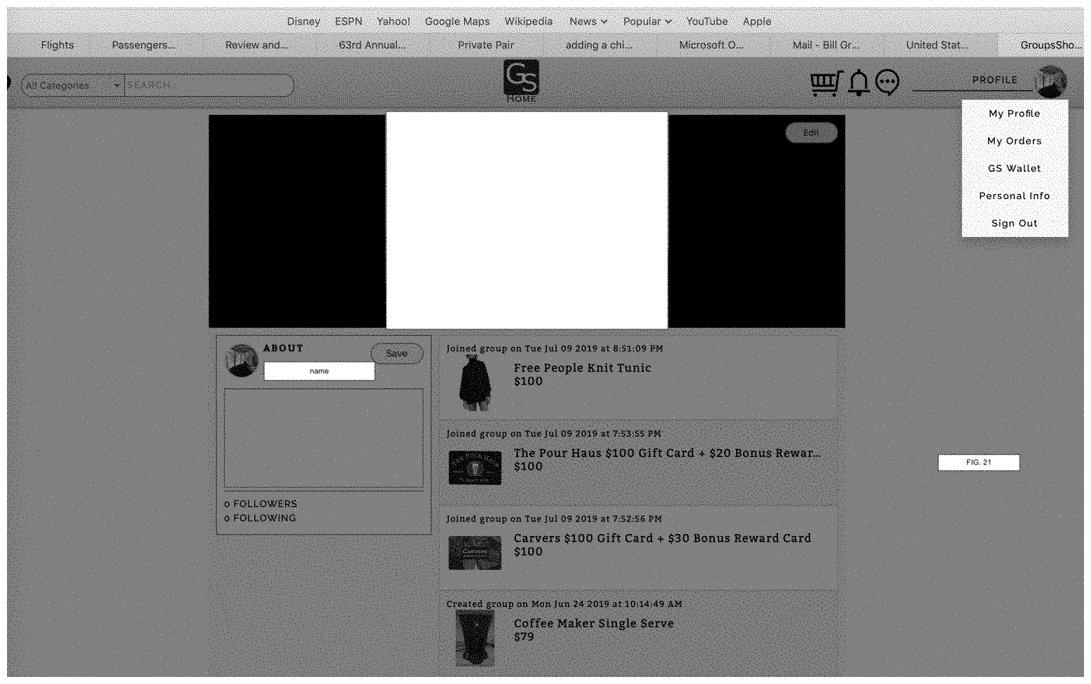

FIG. 21 illustrates a dropdown window where in the user can add/edit a profile, personal data, privacy settings data, display name data, avatar data, billing data, e-mail data, date of birth data, phone number data, address data; or profile data data which contains name data, users following data, users followed by data, age data, address data, and purchasing history data. In addition, the user can add/edit/view order(s) and their wallet data.

It will be appreciated that embodiments of the invention provide for a transformation of computer memories and displays that is directly analogous to the transformation of other physical objects, such as an advertising billboard, by the incorporation of advertising or messages thereon. The software comprising each server is a sequence of bits comprising encoded instructions for processors that interpret the encoded instructions and thereby run the server. Such software is stored in computer-readable memories, or storage means, such as: hard disk drives; semiconductor devices such as read-only memories, random access memories, flash memories and solid state drives; and optical storage means such as CDs and DVDs. The invention provides for the transformation of such physical devices (computer-readable memories). The storage of the software in such memories physically transforms those memories so that a portion of them encodes the data in a form that can be retrieved and run by a processor. Embodiments of the invention thereby transform the physical object which is computer-readable memory or memories containing software. Embodiments of the invention further transform the physical object that is the user's display device by causing it to display campaigns in a combined social media platform.

It will be appreciated that the above description relates to the preferred embodiments by way of example only. Many variations on the system and method for delivering the invention without departing from the spirit of same will be clear to those knowledgeable in the field, and such variations are within the scope of the invention as described and claimed, whether or not expressly described.

What is claimed is:

1. A system for merchandising and socializing within a browser window to a user using a campaign module over Internet, which includes:
a web based user interface program residing on a computer based server which is operably connected to the Internet, said program requiring access through a browser window and registration by way of one or more user-specified operations to be applied to signals and/or states to be provided as operands for the one or more user-specified operations categorizing themselves as at least one of a buyer or seller;
a first campaign module of said web based user interface program requiring one or more user-specified operations to be applied to signals and/or states to be provided as operands for the one or more user-specified operations for creating a first campaign data including at least one of a first product data and a first service data, including at least one of a first description data and a first image data, and including at least one of a first defined price data and a first defined number of units data set by a first user, said first campaign module generating output signals and/or states based at least in part on said creating for rendering viewable a first campaign data in a first sub-window of said browser window;
a campaign database storing said first campaign data;
a second module of said web based user interface program determining a first acceptance signal by way of one or more user-specified operations to be applied to signals and/or states to be provided as operands for the one or more user-specified operations including at least one of an acceptable defined price data and acceptable defined number of units data is provided, said second module generating output signals and/or states based at least in part on said determining, wherein said second module include generating an output signal including alive campaign data and rendering said first campaign data viewable in a second sub-window of said browser window enabling completing an acquisition transaction on one of said first product and said first service data by at least one user of said web based user interface program; and
a messaging module of said web based user interface program for generating messages based at least in part on one or more user-specified operations to be applied to signals and/or states to be provided as operands for the one or more user-specified operations, and generating output signals and/or states based at least in part on said generating which renders a viewable messaging sub-window in said browser window adjacent one of said first sub-window and said second sub-window within said browser window for user to user communication through said messaging sub-window without exiting said browser window.

2. The system of claim 1, wherein said messaging module provides message signals between users joined to said first campaign.

3. The system of claim 1, which includes a third module for transforming said first campaign data by way of one or more user-specified operations to be applied to signals and/or states to be provided as operands for the one or more user-specified operations to include at least one of a first redefined defined price data and a first redefined bulk purchase number of units data set by a second user and a monitoring module which upon at least one of the redefined price data and said redefined bulk purchase number of units being accepted, said third module for transforming generates output signals and/or states based at least in part on the transforming which are rendered in said second sub-window.

4. The system of claim 1, wherein said system further includes a fourth module for scanning and comparing said campaign database against a second campaign data and based one or more user-specified operations to be applied to signals and/or states to be provided as operands for the one or more user-specified operations determining a like prior campaign data in said campaign database, and generating an output signal to said user of said like prior campaign, and a signal prompting said user to select said like prior campaign or to continue with said second campaign for being stored in said campaign database.

5. The system of claim 1, wherein said first campaign module by way of one or more user-specified operations to be applied to signals and/or states to be provided as operands for the one or more user-specified operations require one of creation and editing product and service data, including categorizing data, image data, description data, price data and a selling point description message data.

6. The system of claim 5, herein said first campaign module by way of one or more user-specified operations to be applied to signals and/or states to be provided as operands for the one or more user-specified operations require creation and editing of shipment data, address data, weight data, and fulfillment data.

7. The system of claim 1, wherein said first campaign module provides an output signal rendering image data and text data in a third sub-window of said browser window in an orbital pattern such that when cursor pans over said data in said third window said data moves in an orbit permitting a predetermined number of image and text to be rendered within said orbit.

8. The system of claim 7, wherein said image data includes a user photo data and said text data includes user name data, email address data, and phone number data.

9. The system of claim 1, wherein said first campaign module generating an output signal rendering said sub-window of a browser window said web based user interface program, employing said campaign database containing campaigns including customized rendering instructions, said campaign server connected to a communications network for receiving campaign data requests, retrieving a campaign data from said campaign database according to said campaign data requests and associated campaign member user data for said requested campaign, and formatting said campaign data and campaign member user data and rendering in said fourth sub-window according to said customized rendering instructions.

10. The system of claim 1, which is further characterized to generate output signal rendering registrant user data through said web based user interface in a registrant sub-window in an orbital pattern such that when a cursor pans over said registrant user data, said registrant user data moves in the orbital pattern and wherein permitting a predetermined number of registrant user data be rendered within the orbital pattern.

11. The system of claim 1, which further includes a tracking module by way of one or more user-specified operations to be applied to signals and/or states to be provided as operands for the one or more user-specified operations to record tracking data comprising user identifying information and user information requests wherein said system maintains a list of campaign data, each campaign data comprising one or more item for sale, and generates an output alert signal displaying an alert to a user in messaging sub-window, each alert signal including a link to view an item in a promotion, where said tracking module determines from the recorded tracking data that the user is a candidate for viewing the promotion.

12. The system of claim 1, wherein said first module by way of one or more user-specified operations to be applied to signals and/or states to be provided as operands for the one or more user-specified operations renders image data and text data in a third sub-window of said browser window via said web based user interface in an orbital pattern such that when a cursor passes over said image data and text data, said image data and text data move in the orbital pattern permitting a predetermined number of image data and text data to be rendered within said orbital pattern.

13. In a system for socializing within a browser window over Internet, which includes:
a web based user interface program residing on a computer based server which is operably connected to the Internet, said interface program requiring by way of one or more user-specified operations to be applied to signals and/or states to be provided as operands for the one or more user-specified operations requiring access to said web based user interface program through a browser window and registering user data, said program generating an output signal rendering a first sub-window with said user data in a sub-window of said browser window via said web based user interface program in an orbital pattern such that as a cursor pans over said user data in said sub-window said user data moves with in said orbital pattern permitting a predetermined number user data to be rendered within said orbital pattern; and
a messaging module based at least in part on one or more user-specified operations to be applied to signals and/or states to be provided as operands for the one or more user-specified operations generating output signals rendering a viewable messaging sub-window in said browser window adjacent said first sub-window within said browser window for user to user communication without exiting said browser window.

14. The system of claim 13, wherein said user data includes image data having a user photo data and includes text data having user name data, email address data, and phone number data.

15. The system of claim 13, wherein said user data includes personal data, privacy settings data, display name data, avatar data, billing data, e-mail data, date of birth data, phone number data, address data; or profile data data which contains name data, users following data, users followed by data, age data, address data, and purchasing history data.
